(19) United States
(12) Patent Application Publication
(10) Pub. No.: US 2014/0029741 A1
(43) Pub. Date: Jan. 30, 2014

(54) Platform to Interact with Multiple Electronic Private Automatic Branch Exchange (EPBAX) Systems

(71) Applicants: Raghavendra Subhash, Bangalore (IN); Chethak T K, Bangalore (IN); Kiran Kanth A, Bangalore (IN); Karthikeyan Kanniappan, Bangalore (IN)

(72) Inventors: Raghavendra Subhash, Bangalore (IN); Chethak T K, Bangalore (IN); Kiran Kanth A, Bangalore (IN); Karthikeyan Kanniappan, Bangalore (IN)

(73) Assignee: SAP AG, Walldorf (DE)

(21) Appl. No.: 13/557,866

(22) Filed: Jul. 25, 2012

(51) Int. Cl. H04M 7/00

(52) U.S. Cl. 379/229

(57) ABSTRACT

Embodiments comprise apparatuses and methods allowing interaction with multiple electronic private automatic branch exchange (EPABX) systems. Certain embodiments employ a three layer architecture comprising middleware interposed between a front end comprising a user interface (UI), and a backend comprising a telephone server and the corresponding EPABX system. The middleware performs centralized queuing, administration, and monitoring functions. Requests received from a user via the front end layer may be queued and then dispatched to the telephone server of the appropriate EPABX system, as determined by execution of an algorithm by an engine of the middleware. A notification (e.g. text, email) may be sent to the user regarding a status of the request processed at the EPABX system.

### BACKGROUND

Embodiments of the present invention relate to voice systems, and in particular to platforms allowing interaction with multiple electronic private automatic branch exchange (EPABX) systems.

Unless otherwise indicated herein, the approaches described in this section are not prior art to the claims in this application and are not admitted to be prior art by inclusion in this section.

While email and text have recently emerged as valuable channels of communication, voice remains a key way in which individuals transmit information to one another.

Large institutions may be distributed across various different physical locations. Individuals within an organization may be assigned a telephone, with a different EPABX system used in each location.

Conventionally, if an employee or system administrator seeks to implement a telephone operation such as personal identification number (Pin) reset, Pin activation, or a change to profile/unlock/lock/name change etc., then this must be implemented manually. In particular, a member of the information technology (IT) staff at the particular location has to perform the operation on the respective EPABX system. This can require coordinated activity between multiple individuals over large geographic distances and time zones.

Accordingly, the present disclosure addresses these and other issues with systems and methods allowing interaction with multiple EPABX systems.

### SUMMARY

Embodiments comprise apparatuses and methods allowing interaction with multiple electronic private automatic branch exchange (EPABX) systems. Certain embodiments employ a three layer architecture comprising middleware interposed between a front end comprising a user interface (UI), and a backend comprising a telephone server and the corresponding EPABX system. The middleware performs centralized queuing, administration, and monitoring functions. Requests received from a user via the front end layer may be queued and then dispatched to the telephone server of the appropriate EPABX system, as determined by execution of an algorithm by an engine of the middleware. A notification (e.g. text, email) may be sent to the user regarding a status of the request processed at the EPABX system.

An embodiment of a computer-implemented method comprises causing a request processing system to receive from a user, an electronic private automatic branch exchange (EPABX) request. An engine of the request processing system is caused to reference a database to obtain information relevant to the EPABX request. The engine is caused to process the request and the information to identify an appropriate EPABX system from a plurality of EPABX systems. The request processing system is caused to dispatch a command to the appropriate EPABX system via a server.

An embodiment of a non-transitory computer readable storage medium embodies a computer program for performing a method comprising causing a request processing system to receive from a user, an electronic private automatic branch exchange (EPABX) request. An engine of the request processing system is caused to reference a database to obtain information relevant to the EPABX request. The engine is caused to process the request and the information to identify an appropriate EPABX system from a plurality of EPABX systems. The request processing system is caused to dispatch a command to the appropriate EPABX system via a server.

An embodiment of a computer system comprises one or more processors and a software program executable on said computer system. The software program is configured to cause a request processing system to receive from a user, an electronic private automatic branch exchange (EPABX) request. The software program is also configured to cause an engine of the request processing system to reference a database to obtain information relevant to the EPABX request. The software program is further configured to cause the engine to process the request and the information to identify an appropriate EPABX system from a plurality of EPABX systems. The software program is configured to cause the request processing system to dispatch a command to the appropriate EPABX system via a server.

In certain embodiments the EPABX request is communicated to the request processing system through an https connection.

According to some embodiments the command is communicated to the server through a remote function call (RFC).

Particular embodiments further comprise returning to the user, a notification of completion of the command by the appropriate EPABX system.

In various embodiments the request processing system further comprises a messaging component configured to send the notification.

According to certain embodiments the request processing system and the database comprise a middleware layer located between a front end layer comprising a user interface, and a backend layer comprising the telephone server and the appropriate EPABX system.

In some embodiments the request processing system further comprises a queuing component configured to receive the EPABX request.

The following detailed description and accompanying drawings provide a better understanding of the nature and advantages of particular embodiments.

### BRIEF DESCRIPTION OF THE DRAWINGS

FIG. 1 shows a simplified view of a system according to an embodiment.

FIG. 2 shows a more detailed view of a three level architecture according to an embodiment.

FIG. 3 is a simplified view showing a process flow according to an embodiment.

FIG. 4 illustrates hardware of a special purpose computing machine configured to interact with multiple EPABX systems according to an embodiment.

FIG. 5 illustrates an example of a computer system.

### DETAILED DESCRIPTION

Described herein are techniques for interacting with multiple EPABX systems. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

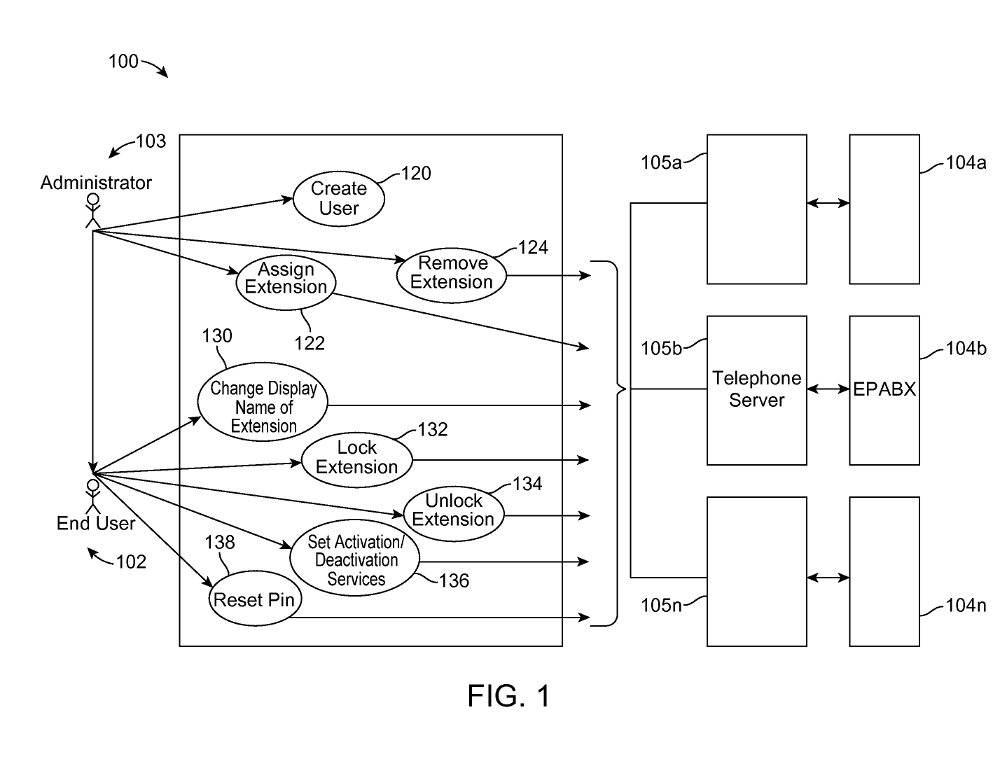

Embodiments comprise apparatuses and methods allowing interaction with multiple electronic private automatic branch exchange (EPABX) systems. As indicated in the highly simplified schematic view of FIG. 1, a system 100 according to an embodiment may be deployed between a user such as an end user 102 or an administrator 103, and a plurality of EPABX systems 104a-n.

The administrator may seek to interact with an appropriate EPABX system through the system. In particular, the administrator may seek to take actions such as creating 120 a user, assigning 122 an extension to a user, or removing 124 an extension from a user.

An end user of an EPABX system may also seek to interact with the appropriate EPABX system through the system. In particular, the end user may seek to take actions such as changing 130 a displayed name of an extension, locking 132 and extension, unlocking 134 and extension, setting 136 activation/deactivation services, and/or resetting 138 a Pin.

While not explicitly indicated in FIG. 1, the Administrator is also empowered to perform all of the actions of an end user. Thus the Administrator may also take the actions 130, 132, 134, 136, and 138.

As shown in FIG. 1, the system serves to receive these user/administrator requests, and then to forward them to the appropriate EPABX system via a telephone server 105a-n. As further discussed below, the system may in turn receive confirmation of the implementation of the request at the EPABX system, and forward a notification thereof back to the end user or administrator.

Embodiments may offer certain benefits over conventional approaches for interacting with EPBAX systems. For example, telephone extension operations like Pin reset, activation on profile, Name change, Locking/Unlocking may be managed from a single location, irrespective of where the applicable EPBAX system actually resides.

Moreover, embodiments allow such operations to be performed independent of the vendor of a particular EPBAX system. This aspect may be particularly valuable for global distribution of EPBAX systems results in their having to be adapted to different national infrastructures and standards that are supported by different vendors.

Embodiments may also allow for centralized management of EPABX systems. For example, billing can be tracked centrally at a head office, rather than being done at each EPABX location separately.

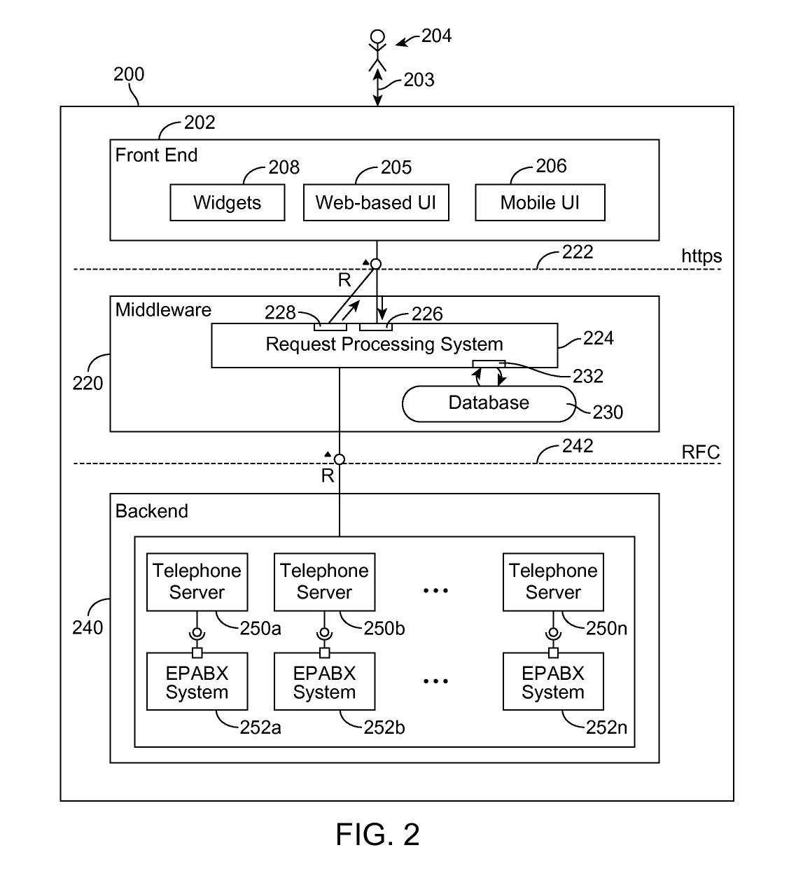

FIG. 2 shows a more detailed view of a three level architecture of according to an embodiment. Architecture 200 comprises a Front End layer 202 that is configured to receive and communicate information 203 of various kinds with a user 204. According to certain embodiments, this communication may take place through a web-based user interface 205. In particular embodiments, the Front End may feature a mobile interface 206 that is specifically configured to meet the demands of a user having a portable electronic device such as a smartphone or tablet.

The Front End layer 202 may comprise one or more widgets 208. Such widgets may comprise a compact application facilitating user interaction with particular platforms or environments.

The architecture 200 of FIG. 2 further comprises a middleware layer 220. This middleware layer is configured to interact with the Front End layer utilizing a hyper text transfer protocol secure (https) link 222.

The middleware layer 220 of FIG. 2 comprises a request processing system 224. The request processing system comprises a queuing component 226 that is configured to receive via the Front End, user requests to an EPABX system, and to arrange those requests in a queue for processing. The request processing system further comprises a messaging component 228 that is configured to provide notifications to the user via the Front End, regarding a status of completion of requests.

The middleware layer 220 of FIG. 2 comprises a database 230. The database includes information regarding telephone access of individuals. Examples of information which may be stored in the database include but are not limited to:
individual name;
individual extension;
assigned EPABX system;
EPABX systems identification and RFC communication information;
Employee information such as Name, Telephone Extension, EPABX system identification, email ID and others.

Accordingly, the request processing system further includes an engine 232 that is configured to receive a request from the Front End, and to reference the database in order to obtain information relevant to that request. Based upon that information obtained, the engine is configured to execute an algorithm causing the system to dispatch a command to the appropriate relevant EPABX system.

In particular, the request processing system of the middleware layer is in communication with the backend layer 240 via a remote function call (RFC) mechanism 242. The backend layer comprises a telephone server 250a-n that is in communication with a respective EPABX system 252a-n

The telephone server is an independent component and that exposes application programming interfaces (APIs) that can be invoked from the middleware. It is the role of the telephone server to interface with the EPABX system, and to execute commands dispatched thereto. Examples of such commands include assignment or removal of extensions, Pin management etc. as has been described above.

The request processing system may be configured to receive from the backend (e.g. via the telephone server), an indication of successful processing of the command at the EPABX system. This indication may be communicated as part of the RFC. In response, the messaging component of the request processing system may be configured to communicate a notification (e.g. text, email) to the user via the https link and the front end, regarding successful completion of the issued request.

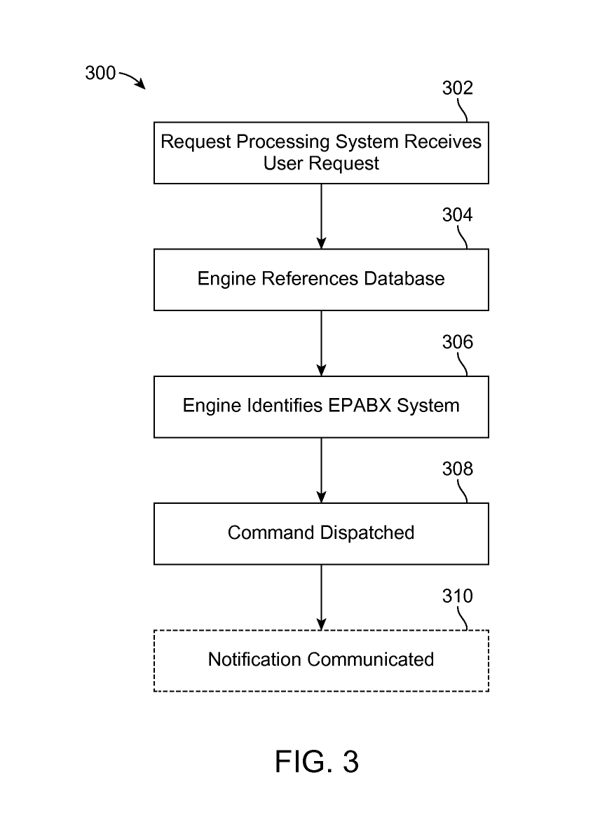

FIG. 3 is a simplified view showing a process flow 300 according to an embodiment. In a first step 302, a request processing system receives a user request.

In a second step 304, the engine of the request processing system references a database to obtain information relevant to the user request. In a third step 306, the engine processes the request and the information according to an algorithm, to identify an appropriate EPABX system.

In a fourth step 308, the system dispatches a command to the EPABX system. In an optional fifth step 310, notification of successful completion of the command at the EPABX system, is communicated from the request processing system back to the user.

### EXAMPLE

An embodiment of a system was implemented utilizing software and databases available from SAP AG of Walldorf, Germany. This particular embodiment utilized the NetWeaver™ Advanced Business Application Programming (ABAP) platform as the middleware layer providing central queuing, administration, and monitoring functions. The ABAP platform was in communication with respective telephone servers in the form of JAVA™ Connector (JCO) server instances.

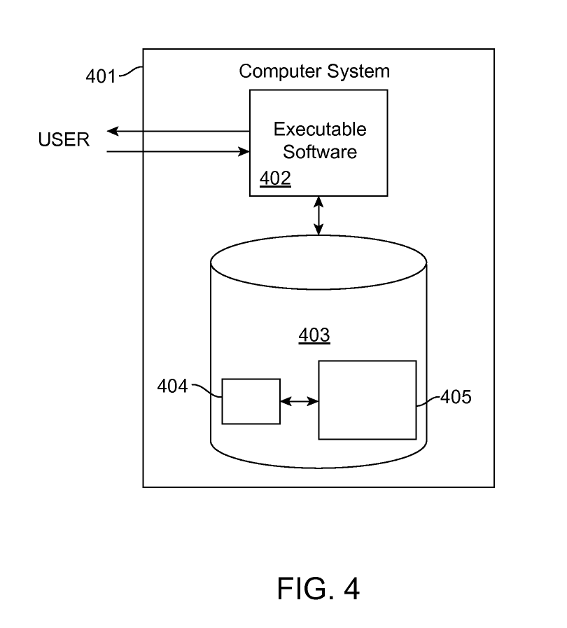

FIG. 4 illustrates hardware of a special purpose computing machine configured to interact with multiple EPABX systems according to an embodiment. In particular, computer system 400 comprises a processor 402 that is in electronic communication with a non-transitory computer-readable storage medium 403. This computer-readable storage medium has stored thereon code 405 corresponding to an engine. Code 404 corresponds to a queuing component. Code may be configured to reference data (e.g. EPABX data) stored in a database of a non-transitory computer-readable storage medium, for example as may be present locally or in a remote database server. Software servers together may form a cluster or logical network of computer systems programmed with software programs that communicate with each other and work together in order to process requests.

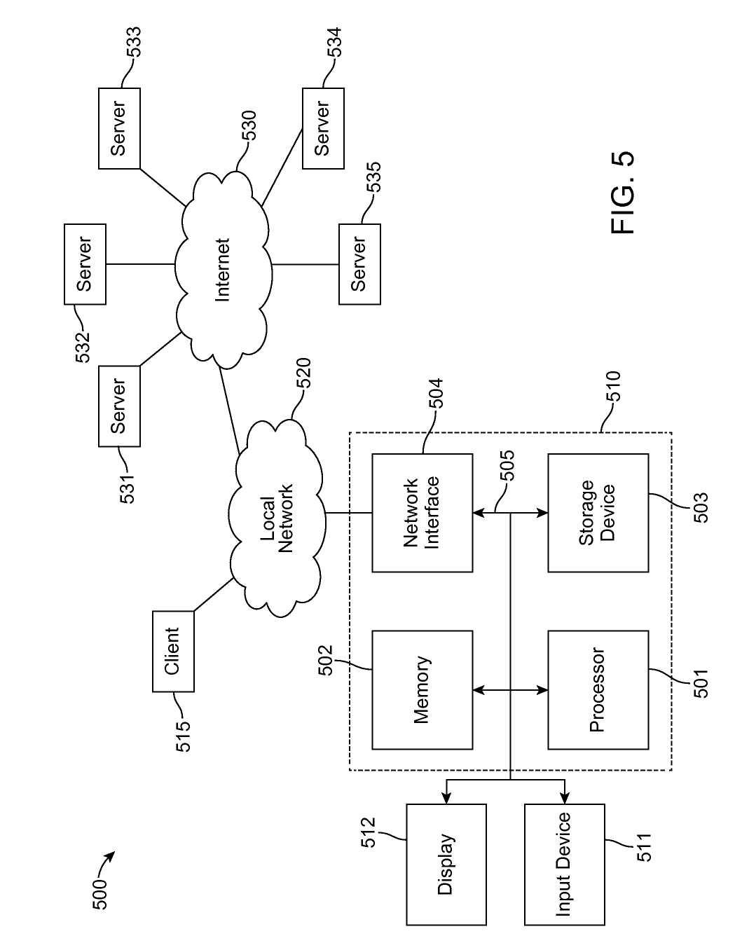

An example computer system 510 is illustrated in FIG. 5. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including information and instructions for performing the techniques described above, for example. This memory may also be used for storing variables or other intermediate information during execution of instructions to be executed by processor 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 503 may include source code, binary code, or software files for performing the techniques above, for example. Storage device and memory are both examples of computer readable mediums.

Computer system 510 may be coupled via bus 505 to a display 512, such as a cathode ray tube (CRT) or liquid crystal display (LCD), for displaying information to a computer user. An input device 511 such as a keyboard and/or mouse is coupled to bus 505 for communicating information and command selections from the user to processor 501. The combination of these components allows the user to communicate with the system. In some systems, bus 505 may be divided into multiple specialized buses.

Computer system 510 also includes a network interface 504 coupled with bus 505. Network interface 504 may provide two-way data communication between computer system 510 and the local network 520. The network interface 504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 504 sends and receives electrical, electromagnetic, or optical signals that carry digital data streams representing various types of information.

Computer system 510 can send and receive information, including messages or other interface actions, through the network interface 504 across a local network 520, an Intranet, or the Internet 530. For a local network, computer system 510 may communicate with a plurality of other computer machines, such as server 515. Accordingly, computer system 510 and server computer systems represented by server 515 may form a cloud computing network, which may be programmed with processes described herein. In the Internet example, software components or services may reside on multiple different computer systems 510 or servers 531-535 across the network. The processes described above may be implemented on one or more servers, for example. A server 531 may transmit actions or messages from one component, through Internet 530, local network 520, and network interface 504 to a component on computer system 510. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
causing a request processing system to receive from a user, an electronic private automatic branch exchange (EPABX) request;
causing an engine of the request processing system to reference a database to obtain information relevant to the EPABX request;
causing the engine to process the request and the information to identify an appropriate EPABX system from a plurality of EPABX systems; and
causing the request processing system to dispatch a command to the appropriate EPABX system via a server.

2. A method as in claim 1 wherein the EPABX request is communicated to the request processing system through an https connection.

3. A method as in claim 1 wherein the command is communicated to the server through a remote function call (RFC).

4. A method as in claim 1 further comprising returning to the user, a notification of completion of the command by the appropriate EPABX system.

5. A method as in claim 4 wherein the request processing system further comprises a messaging component configured to send the notification.

6. A method as in claim 1 wherein the request processing system and the database comprise a middleware layer located between a front end layer comprising a user interface, and a backend layer comprising the telephone server and the appropriate EPABX system.

7. A method as in claim 1 wherein the request processing system further comprises a queuing component configured to receive the EPABX request.

8. A non-transitory computer readable storage medium embodying a computer program for performing a method, said method comprising:
causing a request processing system to receive from a user, an electronic private automatic branch exchange (EPABX) request;
causing an engine of the request processing system to reference a database to obtain information relevant to the EPABX request;
causing the engine to process the request and the information to identify an appropriate EPABX system from a plurality of EPABX systems; and
causing the request processing system to dispatch a command to the appropriate EPABX system via a server.

9. A non-transitory computer readable storage medium as in claim 8 wherein the EPABX request is communicated to the request processing system through an https connection.

10. A non-transitory computer readable storage medium as in claim 8 wherein the command is communicated to the server through a remote function call (RFC).

11. A non-transitory computer readable storage medium as in claim 8 wherein the method further comprises returning to the user, a notification of completion of the command by the appropriate EPABX system.

12. A non-transitory computer readable storage medium as in claim 11 wherein the request processing system further comprises a messaging component configured to send the notification.

13. A non-transitory computer readable storage medium as in claim 8 wherein the request processing system and the database comprise a middleware layer located between a front end layer comprising a user interface, and a backend layer comprising the telephone server and the appropriate EPABX system.

14. A non-transitory computer readable storage medium as in claim 8 wherein the request processing system further comprises a queuing component configured to receive the EPABX request.

15. A computer system comprising:
one or more processors;
a software program, executable on said computer system, the software program configured to:
cause a request processing system to receive from a user, an electronic private automatic branch exchange (EPABX) request;
cause an engine of the request processing system to reference a database to obtain information relevant to the EPABX request;
cause the engine to process the request and the information to identify an appropriate EPABX system from a plurality of EPABX systems; and
cause the request processing system to dispatch a command to the appropriate EPABX system via a server.

16. A computer system as in claim 14 wherein the EPABX request is communicated to the request processing system through an https connection.

17. A computer system as in claim 14 wherein the command is communicated to the server through a remote function call (RFC).

18. A computer system as in claim 14 wherein the software program is further configured to return to the user, a notification of completion of the command by the appropriate EPABX system.

19. A computer system as in claim 17 wherein the request processing system further comprises a messaging component configured to send the notification.

20. A computer system as in claim 14 wherein the request processing system and the database comprise a middleware layer located between a front end layer comprising a user interface, and a backend layer comprising the telephone server and the appropriate EPABX system.
